(19) United States
(12) Patent Application Publication
(10) Pub. No.: US 2022/0373126 A1
(43) Pub. Date: Nov. 24, 2022

(54) ARTICULATED STRUCTURE AND SUSPENSION ARM STAND HAVING THE SAME

(71) Applicant: Ningbo Tlingt Technology Co., Ltd., Ningbo (CN)

(72) Inventor: Qunying Tang, Ningbo (CN)

(21) Appl. No.: 17/688,835

(22) Filed: Mar. 7, 2022

(30) Foreign Application Priority Data
May 24, 2021 (CN) 202110567704.7

(51) Int. Cl. F16M 11/04; A47B 21/03; F16M 13/02

(52) U.S. Cl. CPC F16M 11/041; A47B 21/03; F16M 13/022; F16M 2200/063

(57) ABSTRACT

Provided is an articulated structure for connecting at least one arm rod, including a first connecting piece, a second connecting piece, a friction member and a pressing assembly. The friction member is inserted into one end of the arm rod, one end of the arm rod is articulated between the first connecting piece and the second connecting piece through a driving member, the driving member includes a stud, and the stud of the driving member sequentially penetrates through the first connecting piece, the friction member and one end of the arm rod and then threading mount with the second connecting piece. The pressing assembly is positioned between the first connecting piece and the second connecting piece and driven by the driving member to press against the friction member.

### CROSS-REFERENCE TO RELATED APPLICATION

The present application is based on and claims the priority benefits of China application No. 202110567704.7, filed on May 24, 2021. The entirety of the above-mentioned patent application is hereby incorporated by reference herein and made a part of this specification.

### BACKGROUND

### Technical Field

The present application relates to the field of brackets and stands, and more particularly, to an articulated structure and a suspension arm stand having the articulated structure.

### Description of Related Art

A suspension arm stand is mainly used for clamping electronic devices such as microphones, mobile phones, etc. For the applications, one end of the suspension arm stand which holds the electronic devices will be required to be placed at difference positions, therefore the construction of the swivel joint that connect the boom arms is critical, and a better friction force is required.

The joints of the existing suspension arm stands are connected only depend on screws and nuts, and the arms are mainly positioned through the supporting force provided by springs. However, this feature makes its weight capacity is limited by the spring force, if the weight of a clamped object is a bit larger than the bearing capacity of the springs, the suspension arm stand will be unstable to use, and the clamping electronic devices will be suffered from shaking, waggling, or the like, being limited in range of application.

### SUMMARY

In order to broaden the application range of the suspension arm stand, this application provides an articulated structure and a suspension arm stand having the articulated structure.

In a first aspect, this application provides an articulated structure, which adopts the following technical solutions.

An articulated structure can be used for connecting at least one arm rod, includes a first connecting piece, a second connecting piece, a friction member and a pressing assembly, in which the friction member is inserted into one end of the arm rod, one end of the arm rod is articulated between the first connecting piece and the second connecting piece via a driving member, the driving member could be a screw, and the driving member sequentially penetrates through the first connecting piece, the friction member and one end of the arm rod, then threading connected with the second connecting piece, so as to drive the first connecting piece and the second connecting piece to pinch one end of the arm rod, and the pressing assembly is positioned between the first connecting piece and the second connecting piece and through the driving member to press against the friction member.

By adopting the above technical solutions, through tightening the driving member, the pressing assembly will press against the friction member, so as to increase the resistance of the arm rod produced during rotation relative to the first connecting piece and the second connecting piece, thereby increasing the load-bearing capability of the suspension arm stand, and further broadening the application range of the suspension arm stand.

In some embodiments, the pressing assembly includes a first clamping member and/or a second clamping member;

when the pressing assembly includes a first clamping member, the first clamping member is fixed to a side of the first connecting piece facing the second connecting piece, the first clamping member is sleeved outside the stud of the driving member, a first clamping surface is formed on a side of the first clamping member away from the first connecting piece, an outer diameter of the first clamping surface is gradually reduced from the first connecting piece to the second connecting piece, the friction member has a first mating surface that could be matched with the first clamping surface;

when the pressing assembly includes a second clamping member, the second clamping member is fixed to a side of the second connecting piece facing the first connecting piece, the second clamping member is threadedly connected to the stud of the driving member, a second clamping surface is formed on a side of the second clamping member away from the second connecting piece, an outer diameter of the second clamping surface is gradually reduced from the second connecting piece to the first connecting piece, the friction member has a second mating surface that could be matched with the second clamping surface;

when the pressing assembly includes a first clamping member and a second clamping member, the first clamping member is fixed to a side of the first connecting piece facing the second connecting piece, the first clamping member is sleeved outside the stud of the driving member, a first clamping surface is formed on a side of the first clamping member away from the first connecting piece, an outer diameter of the first clamping surface is gradually reduced from the first connecting piece to the second connecting piece, the friction member has a first mating surface adapted to the first clamping surface; and

the second clamping member is fixed to a side of the second connecting piece which come face to face with the first connecting piece, the second clamping member is threadedly connected with the stud of the driving member, a second clamping surface is formed on a side of the second clamping member away from the second connecting piece, an outer diameter of the second clamping surface is gradually reduced from the second connecting piece to the first connecting piece, and the friction member has a second mating surface adapted to the second clamping surface.

By adopting the above technical solutions, when the driving member is tightened, the first clamping surface is brought into close contact with the first mating surface and/or the second clamping surface is brought into close contact with the second mating surface, thereby increasing the resistance of the arm rod produced during rotation relative to the first connecting piece and the second connecting piece, thereby increasing the load-bearing capacity of the arm rod, and further widening the application range of the suspension arm stand.

In a second aspect, the present application provides a suspension arm stand, which adopts the following technical solutions:

A suspension arm stand including:
a base;
a first arm comprising at least one first arm rod;
a second arm comprising at least one second arm rod; and
the articulated structure described above; where
one end of the first arm is articulated to the base through the articulated structure described above, and one end of the second arm is articulated to the other end of the first arm through the articulated structure described above.

By adopting the above technical solutions, the joints of the first arm, the second arm and the base are articulated by the articulated structure, which increases the resistance of the joint between the first arm and the base during relative movements. thereof and the resistance of the joint between the first arm and the second arm during relative movements, thereof, thereby increasing the load-bearing capacity of the arm rod, and further increasing the application range of the arm.

In some embodiments, the first arm includes two first arm rods, and the two first arm rods are parallel to each other;

the second arm includes two second arm rods, and the two second arm rods are parallel to each other.

By adopting the above technical solutions, the two first arm rods are more load-bearing capacity than one first arm rod; the two second arm rods are more load-bearing capacity than one second arm rod; the two first arm rods and the two second arm rods are parallel to each other, so that the first arm rod and the second arm rod can be folded up together in parallel when the suspension arm stand is not in use.

In some embodiments, the suspension arm stand further includes at least one first elastic member for keeping the other end of the first arm rod with a swing-upward tendency, the articulated structure between the first arm and the base is connected to one end of the first elastic member, and the other end of the first elastic member is connected to a middle portion of the first arm rod.

By adopting the above technical solutions, the first elastic member is arranged to provide a supporting force for the first arm rod, so that the first arm rod can withstand a greater force to prevent swinging downwards, thereby improving the stability of the suspension arm stand during use.

In some embodiments, the first elastic member is accommodated in the first arm rod, and the first arm rod has a first through-slot for one end of the first elastic member to pass through.

By adopting the above technical solutions, the other end of the first elastic member is accommodated in the first arm rod, thereby reducing the space occupied by the suspension arm stand.

In some embodiments, the suspension arm stand further includes at least one second elastic member for keeping the other end of the second arm rod with a swing-upward tendency, the articulated structure between the first arm and the second arm is connected to one end of the second elastic member, and the other end of the second elastic member is connected to a middle portion of the second arm rod.

By adopting the above technical solutions, the second elastic member is arranged to provide a supporting force for the second arm rod, so that the second arm rod can withstand a greater force to prevent swinging downwards, thereby improving the stability of the suspension arm stand during use.

In some embodiments, the second elastic member is accommodated in the second arm rod, and the second arm rod has a second through-slot which one end of the second elastic member could pass through.

By adopting the above technical solutions, the other end of the second elastic member is accommodated in the second arm rod, thereby reducing the space occupied by the suspension arm stand.

In some embodiments, the base includes a supporting tube and a damping sleeve, the articulated structure between the first arm and the base has a rotation shaft, the rotation shaft is inserted into the damping sleeve and rotatably connected to the damping sleeve, and the damping sleeve is inserted into the supporting tube and mounted to the supporting tube;
a sidewall of the damping sleeve has an allowance groove for keeping the damping tube with a contraction allowance.

By adopting the above technical solutions, the rotation shaft is rotatably connected to the damping sleeve and supporting tube, so that the first arm will not be able to move unless there is any force on it, thereby improving the stability of the suspension arm stand during use. By utilizing the allowance groove, with the damping sleeve inserting and mounting into the supporting tube, the damping sleeve can be contracted inwardly, so that the outer sidewall of the damping sleeve fits closely with the inner sidewall of the supporting tube, and the inner sidewall of the damping sleeve fits closely with the outer sidewall of the rotation shaft, so that the rotation shaft does not easily to move or shake once the rotation shaft is insert into the supporting tube, thereby improving the stability of the suspension arm stand.

In some embodiments, the suspension arm stand further includes a clamping assembly sets fixed on the base, where the clamping assembly sets includes a fixed clamping plate, a connecting plate having one end fixed on the fixed clamping plate, a supporting plate fixed on the other end of the connecting plate, a movable clamping plate arranged on a side of the supporting plate close to the fixed clamping plate, and a threading bolt connected to the supporting plate and having one end fixed to the movable clamping plate to drive the movable clamping plate to cooperate with the fixed clamping plate for clamping.

By adopting the above technical solutions, via turning the threading bolt to drive the movable clamping plate to approach the fixed clamping plate, so that the movable clamping plate and the fixed clamping plate can be fixed on a plate-like members and then to secure the suspension arm stand via the clamping base. With fast set-up & fold-up, makes this suspension arm stand easy to use.

### BRIEF DESCRIPTION OF THE DRAWINGS

FIG. 1 is a structural schematic diagram of a suspension arm stand according to Embodiment 1 of the present application.

FIG. 2 is a partial side view of an articulated structure according to Embodiment 1 of the present application.

FIG. 3 is an exploded sectional view of a first connecting piece, a second connecting piece, a second arm rod, and a friction member along line A-A of FIG. 2.

FIG. 4 is a partially exploded view of an articulated structure and a base according to Embodiment 1 of the present application.

FIG. 5 is a schematic structural diagram of a clamping assembly according to Embodiment 1 of the present application.

FIG. 6 is a structural schematic diagram of a suspension arm stand according to Embodiment 2 of the present application.

### DESCRIPTION OF THE EMBODIMENTS

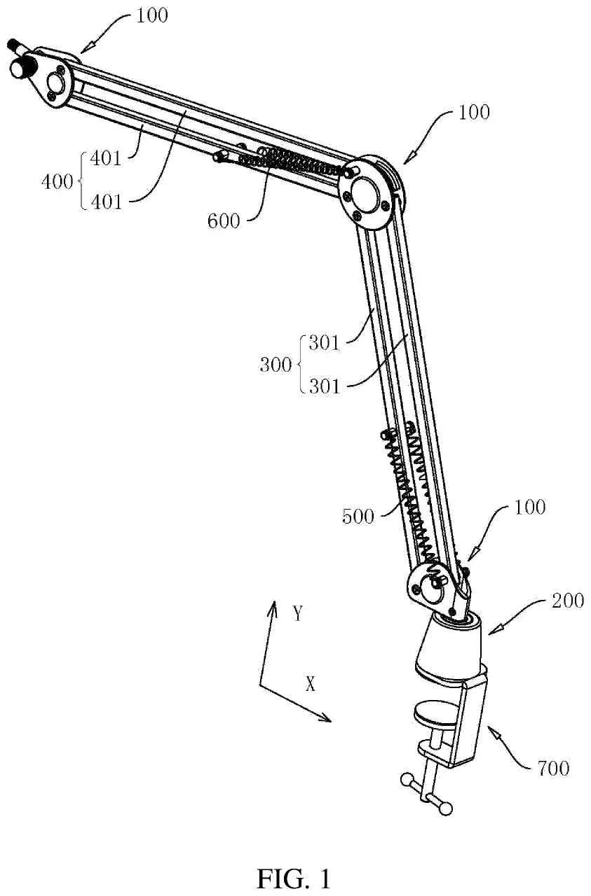

This application is described in detail below in combination with FIGS. 1 to 6.

### Embodiment 1

This embodiment provides a suspension arm stand. Referring to FIG. 1, the suspension arm stand includes a base 200, a first arm 300, a second arm 400, an articulated structure 100 and a clamping assembly 700. The base 200 may be directly fixed to a plate-like member by a screw 104 or the like, or may be clamped and fixed to the plate-like member by a clamping assembly 700. The base 200 in the present application is described by taking the situation of being clamped and fixed to the plate-like member by the clamping assembly 700 as an example. The articulated structure 100 is configured to connect at least one arm; a lower end of the first arm 300 is rotatably connected to the base 200 via the articulated structure 100; an upper end of the first arm 300 is articulated to one end of the second arm 400 via the articulated structure 100; and the other end of the second arm 400 is configured to connect an electronic device and provide support for the electronic device.

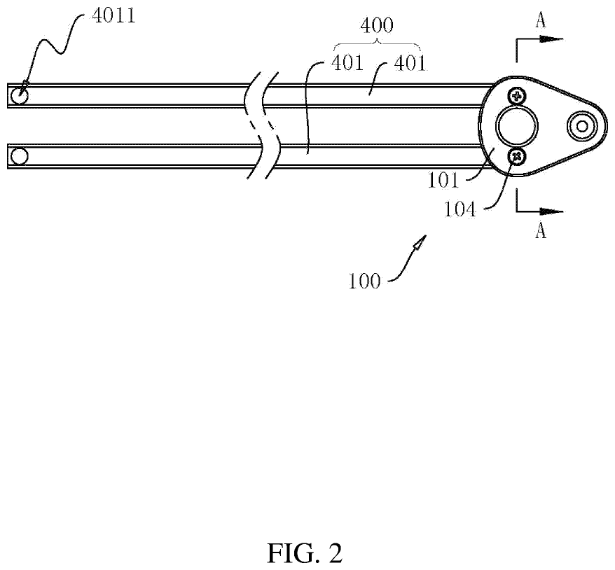

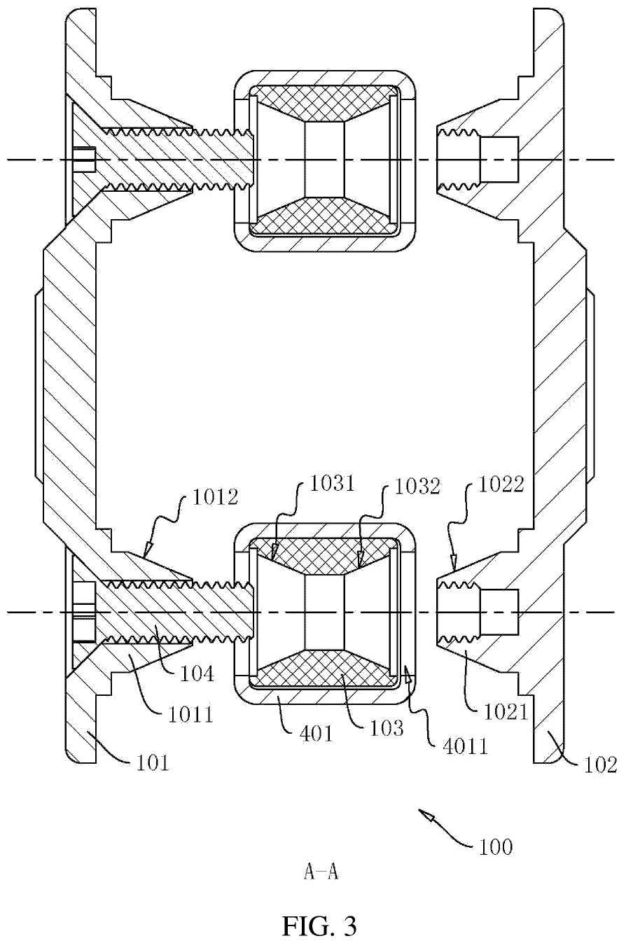

Referring to FIGS. 2 and 3, the articulated structure 100 includes a first connecting piece 101, a second connecting piece 102, a driving member 104, a friction member 103, and a pressing assembly. The driving member 104 could be a screw or a bolt, and in this embodiment, the driving member 104 is described by taking a screw as an example. The second arm 400 includes at least one second arm rod 401. When the articulated structure 100 is connected to one second arm rod 401, the first connecting piece 101 and the second connecting piece 102 are respectively arranged at two sides of one end of the second arm rod 401, and the screw of the driving member 104 sequentially penetrates through the first connecting piece 101 and one end of the second arm rod 401, and then is threadedly connected with the second connecting piece 102, so as to drive the first connecting piece 101 and the second connecting piece 102 to pinch one end of the second arm rod 401.

The friction member 103 is inserted into one end of the second arm rod 401. The friction member 103 could be made of rubber or plastic. The pressing assembly is positioned between the first connecting piece 101 and the second connecting piece 102, and the pressing assembly could be used for pressing against the friction member 103, so as to increase the resistance of the second arm rod 401 during rotation relative to the first connecting piece 101 and the second connecting piece 102, so that the second arm rod 401 could support a heavier object.

In one embodiment, the pressing assembly comprises a first clamping member 1011, and the first clamping member 1011 is fixed to a side of the first connecting piece 101 facing the second connecting piece 102. The first clamping member 1011 is sleeved outside of the driving member 104. A through hole 4011 is provided on a sidewall of the second arm rod 401 abutting against the first connecting piece 101. The through hole 4011 is configured for the first clamping member 1011 to pass through, and the first clamping member 1011 penetrates through the through hole 4011 to abut against one side of the friction member 103. A first clamping surface 1012 is formed on a side of the first clamping member 1011 close to the second connecting piece 102, and the diameter of the first clamping surface 1012 is gradually reduced from the first connecting piece 101 to the second connecting piece 102. The first clamping surface 1012 may be a tapered surface or a curved surface that is concave or convex. In this embodiment, the first clamping surface 1012 is described by taking a tapered surface as an example. The contact surface of the friction member 103 to the first clamping surface 1012 will make a first matching surface 1031. When the driving member 104 is tightened, the first clamping member 1011 presses the friction member 103 to deform the friction member 103, so that the first clamping surface 1012 fits closely with the first matching surface 1031, thereby increasing the resistance of the second arm rod 401 upon the movements relative to the first connecting piece 101.

In another embodiment, the pressing assembly includes a second clamping member 1021. The second clamping member 1021 is fixed to a side of the second connecting piece 102 which comes face to face with the first connecting piece 101. A through hole 4011 is provided on a sidewall of the second arm rod 401 abutting against the second connecting piece 102. The through hole 4011 is configured for the second clamping member 1021 to pass through. The second clamping member 1021 penetrates through the through hole 4011 to abut against the other side of the friction member 103. The second clamping member 1021 is threadedly connected to the stud of the driving member 104. A second clamping surface 1022 is formed on a side of the second clamping member 1021 close to the first connecting piece 101. The diameter of the second clamping surface 1022 is gradually reduced from the second connecting piece 102 to the first connecting piece 101. The second clamping surface 1022 may be a tapered surface, or may be a curved surface that is concave or convex. In this embodiment, the second clamping surface 1022 is described by taking a tapered surface as an example. The contact area of the friction member 103 to the second clamping surface 1022 will form a second matching surface 1032. When the driving member 104 is tightened, the second clamping member 1021 presses the friction member 103 to deform the friction member 103, so that the second clamping surface 1022 fits closely with the second matching surface 1032, thereby increasing the resistance of the second arm rod 401 upon the movements relative to the first connecting piece 101 and the second connecting piece 102.

In another embodiment, the pressing assembly includes the first clamping member 1011 and the second clamping member 1021 as described above, and the specific structure is not described herein. When the driving member 104 is tightened, the first clamping member 1011 and the second clamping member 1021 will come close to each other to pinch the friction member 103 from two sides to deform the friction member 103, so that the first clamping surface 1012 is closely fitting with the first matching surface 1031, and the second clamping surface 1022 is closely fitting with the second matching surface 1032. This further increasing resistance of the second arm rod 401 upon the movements relatives to the first connecting piece 101 and the second connecting piece 102.

Referring to FIGS. 1 and 3, the first arm 300 includes at least one first arm rod 301, and the second arm 400 includes at least one second arm rod 401. The direction indicated by an arrow X is right, and the direction indicated by an arrow Y is upward. The first arm rod 301 extends obliquely in an upper left direction from the base 200. When there is one first arm rod 301 and one second arm rod 401, the lower end of the first arm rod 301 is articulated to the base 200 via an articulated structure 100, the upper end of the first arm rod 301 and one end of the second arm rod 401 are articulated together via two articulated structures 100, and the two articulated structures 100 share one first connecting piece 101 and one second connecting piece 102.

When there are two first arm rods 301 and two second arm rods 401, the lower ends of the two first arm rods 301 are articulated together by two articulated structures 100, and the two articulated structures 100 share one first connecting piece 101 and one second connecting piece 102. The upper ends of the two first arm rods 301 and one end of the two second arm second arm rods 401 are articulated together by four articulated structures 100, and the four articulated structures 100 share one first connecting piece 101 and one second connecting piece 102. The other end of the two second arm rods 401 are articulated together by two articulated structures 100. The two articulated structures 100 share one first connecting piece 101 and one second connecting piece 102. These two articulated structures 100 are used for connecting and supporting an electronic device. the two first arm rods 301 and the four corresponding articulated points form a parallelogram. The two second arm rods 401 and their corresponding four articulated points form a parallelogram.

When there are two first arm rods 301 and one second arm rod 401, the lower ends of the two first arm rods 301 are articulated together by two articulated structures 100, and the two articulated structures 100 share one first connecting piece 101 and one second connecting piece 102. The upper ends of the two first arm rods 301 and one end of one second arm rod 401 are articulated together by three articulated structures 100, the three articulated structures 100 share one first connecting piece 101 and one second connecting piece 102, and the other end of the second arm rod 401 is for connecting an electronic device.

When there are one first arm rod 301 and two second arm rods 401, the lower end of the first arm rod 301 is articulated to the base 200 by the articulated structure 100. The right ends of the two second arm rods 401 and the upper ends of one first arm rod 301 are articulated together by three articulated structures 100, and the three articulated structures 100 share one first connecting piece 101 and one second connecting piece 102. The left ends of the two second arm rods 401 are articulated together by two articulated structures 100, the two articulated structures 100 share one first connecting piece 101 and one second connecting piece 102, and the two articulated structures 100 are fixedly connected to the electronic device. In this embodiment, two first arm rods 301 and two second arm rods 401 are described as an example.

In order to improve the load-bearing capacity of the suspension arm stand, the suspension arm stand further includes at least one first elastic member 500. The first elastic member 500 could be a tension spring, or an elastic rope. In this embodiment, the first elastic member 500 is described by taking a tension spring as an example. When there is one tension springs, one end of the tension spring is suspended from the middle portion in the longitudinal direction of the first arm rod 301 via a pin, and the other end of the tension spring is suspended on the first connecting piece 101 which between the base 200 and the first arm rod 301 via a pin. The other end of the tension spring is located on the right side of the tension spring, so as to provide a tension force for the first arm rod 301, so that the upper end of the first arm rod 301 keeps a tendency to lift right upward. The outer sidewall of the pin is provided with a suspension groove for hanging or suspending the two ends of the tension spring. When there are two tension springs, the two tension springs are symmetrically disposed on both sides of the first arm rod 301. When there are three tension springs, two tension springs are arranged on one side of the first arm rod 301, and a third tension spring is arranged on the other side of the first arm rod 301. Two first elastic members 500 in this embodiment are described as an example.

In order to improve the load-bearing capacity of the suspension arm stand, the suspension arm stand further includes at least one second elastic member 600. The second elastic member 600 could be a tension spring, or an elastic rope, and in this embodiment, the second elastic member 600 is described by taking a tension spring as an example. When there is one tension spring, one end of the tension spring is suspended from the middle portion in the longitudinal direction of the second arm rod 401 via a pin, and the other end of the tension spring is suspended on the first connecting piece 101 between the second arm rod 401 and the first arm rod 301 via a pin. One end of the tension spring is higher than the other end of the tension spring to provide a tension force for the second arm rod 401, so that the other end of the second arm rod 401 with a tendency to lift upward and could hold more heavier electronic devices. The outer sidewall of the pin is provided with a suspension groove for hanging or suspension the two ends of the tension spring, to prevent the two ends of the tension spring from sliding off the pin. When there are two tension springs, the two tension springs are symmetrically placed on both sides of the second arm rod 401. When there are three tension springs, two tension springs are arranged on one side of the second arm rod 401, and a third tension spring is arranged on the other side of the second arm rod 401. Two second elastic members 600 in this embodiment are described as an example.

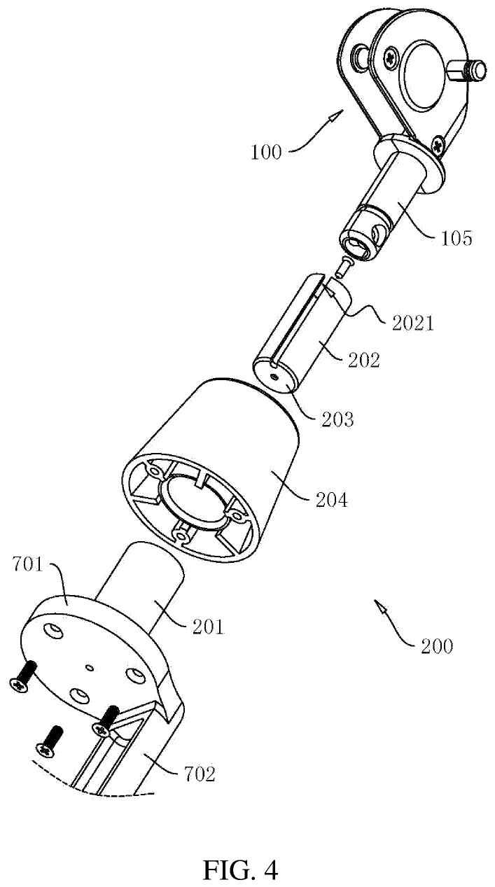

Referring to FIG. 4, the base 200 includes a supporting tube 201 and a damping sleeve 202. The articulated structure 100 at the lower end of the first arm rod 301 has a rotation shaft 105 which could be inserted into the damping sleeve 202, and the rotation shaft 105 is rotatably connected with the damping sleeve 202, and the damping sleeve 202 is mounted into the supporting tube 201 and rotatably connected to the supporting tube 201, so that the first arm rod 301 could be rotatable connect with the supporting tube 201. The damping sleeve 202 may be made of rubber or plastic, and the damping sleeve 202 in this embodiment is described by taking plastic as an example.

In order to prevent the rotation shaft 105 from shaking or waggling while the rotation shaft 105 is inserted into the supporting tube 201, the sidewall of the damping sleeve 202 has an allowance groove 2021. Therefore, when the damping sleeve 202 is inserted into the supporting tube 201, the damping sleeve 202 can be contracted inward to be close fitting with the inner sidewall of the supporting tube 201 as well as the outer sidewall of the rotation shaft 105.

The base 200 further includes a decorative cap 204. The decorative cap 204 is mounted to outside of the supporting tube 201, so as to increase the contact area between the base 200 and a fixing surface.

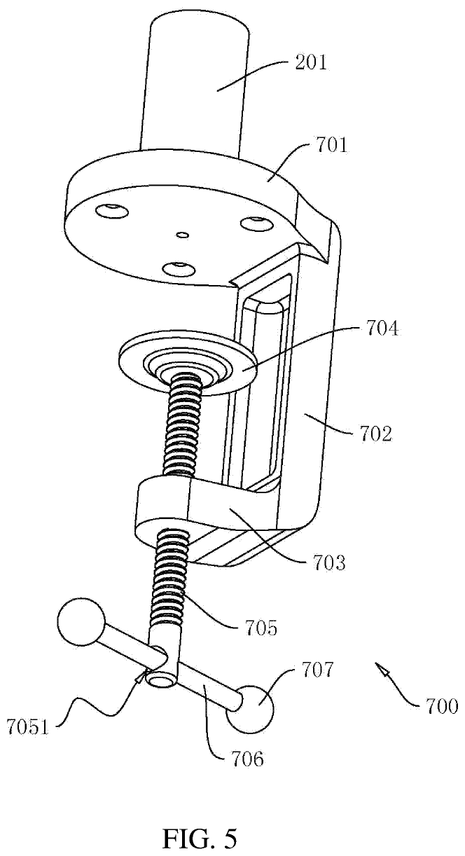

Referring to FIGS. 4 and 5, the clamping assembly 700 includes a fixed clamping plate 701, a connecting plate 702, a supporting plate 703, a movable clamping plate 704, and a threading bolt 705. The fixed clamping plate 701 is fixed under the supporting tube 201. The fixed clamping plate 701 and the supporting tube 201 could be fixed by welding, or integrally formed by die casting molding. The decorative cap 204 is mounted to the upper side of the fixed clamping plate 701 by screws. In order to prevent the damping sleeve 202 easily sliding up and down from the supporting tube 201, the lower end of the damping sleeve 202 is further fixed with a bottom plate 203, and the bottom plate 203 is mounted to the fixed clamping plate 701 by screws. One end of the connecting plate 702 is fixed to one side of the fixed clamping plate 701. The other end of the connecting plate 702 extends downward, and the supporting plate 703 is fixed to the other end of the connecting plate 702. The supporting plate 703 and the fixed clamping plate 701 are located on the same side of the connecting plate 702. The movable clamping plate 704 is located between the clamping plate 701 and the supporting plate 703. The threading bolt 705 penetrates through the supporting plate 703 and is threadedly connected to the supporting plate 703. The upper end of the threading bolt 705 is fixed to the movable clamping plate 704. The movable clamping plate 704 can be driven by the threading bolt 705 to move toward or away from the fixed clamping plate 701. In this way, the base 200 could be clamped and fixed to a counter top, or easily removed from a counter top

In order to conveniently rotate the threading bolt 705 with hands, the clamping assembly 700 further includes a gripping rod 706. A sliding hole 7051 is provided at the lower end of the threading bolt 705, and the axis of the sliding hole 7051 is perpendicular to the axis of the threading bolt 705. The gripping rod 706 penetrates through the sliding hole 7051 and is slidably connected to the threading bolt 705, so as to accomplish the rotation for the gripping rod 706 when in a narrow space. In order to prevent the gripping rod 706 from sliding off the threading bolt 705, two ends of the gripping rod 706 are further fixed with a limiting member 707, and the dimension of the limiting member 707 is larger than the diameter of the sliding hole 7051. In this embodiment, the limiting member 707 is described by taking a spherical shape as an example.

The implementation principle of the suspension arm stand in the embodiment of the present application is as follows: the joint of the suspension arm stand is articulated by the articulated structure 100. By tightening the driving member 104 on the articulated structure 100, the first clamping member 1011 and the second clamping member 1021 approach each other to press the friction member 103 and elastically deform the friction member 103. Therefore, the first clamping surface 1012 is brought into close fit with the first matching surface 1031 and the second clamping surface 1022 is brought into close fitting with the second matching surface 1032, with these features to increase frictional resistance for the movements at each joint, which makes the suspension arm stand can support more heavier electronic devices, meanwhile preventing the electronic devices from shaking or waggling when being clamped on the suspension arm stand.

### Embodiment 2

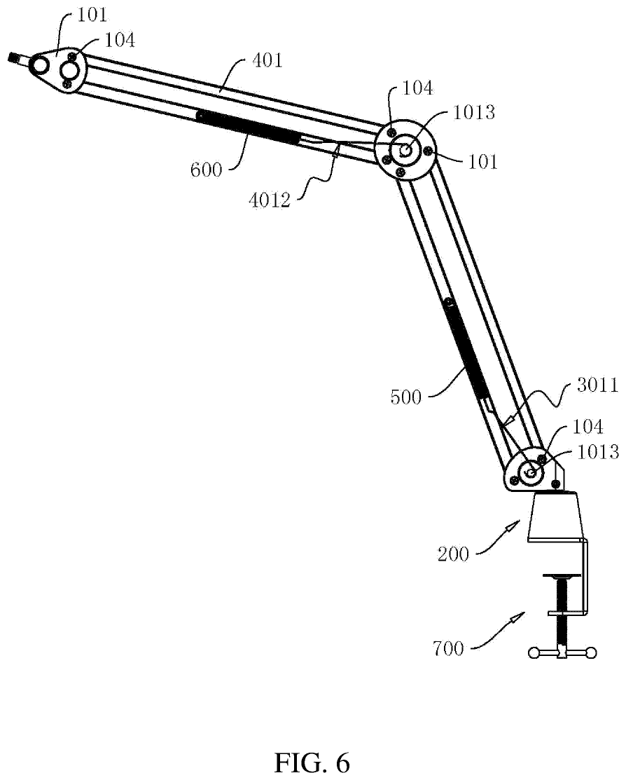

Referring to FIG. 6, the difference from Embodiment 1 lies in that, there are one second elastic members 600 and one first elastic members 500. The first elastic members 500 may be accommodated in the first arm rod 301, and the second elastic members 600 may be accommodated in the second arm rod 401 to reduce the space occupied by the suspension arm stand.

A first through-slot 3011 is provided on a side of the first arm rod 301 close to the base 200, and one end of the first elastic member 500 is suspended from a middle portion of the first arm rod 301 via a pin bolt. The other end of the first elastic member 500 may penetrate through the first arm rod 301 via the first through-slot 3011, and the first connecting piece 101 between the first arm rod 301 and the base 200 is provided with a suspending post 1013 for suspending the other end of the first elastic member 500.

A second through-slot 4012 is provided on a side of the second arm rod 401 that close to the first arm rod 301. One end of the second elastic member 600 is suspended from a middle portion of the second arm rod 401 by a pin bolt, and the other end of the second elastic member 600 may pass through the second arm rod 401 through the second through-slot 4012. The first connecting piece 101 between the second arm rod 401 and the first arm rod 301 has a suspending post 1013 for suspending the other end of the second elastic member 600.

The above description is only preferred embodiments of the present application and is not intended to limit the protection scope of the present application. Therefore, all equivalent changes of the structure, shape or principle according to the spirit of the present application should be all included in the protection scope of the present application.

What is claimed is:

1. An articulated structure for connecting at least one arm rod, comprising a first connecting piece, a second connecting piece, a friction member and a pressing assembly, wherein the friction member is inserted into one end of the arm rod, one end of the arm rod is articulated between the first connecting piece and the second connecting piece through a driving member, the driving member comprises a screw, the screw of the driving member sequentially penetrates through the first connecting piece, the friction member, and one end of the arm rod and then is threadedly connected with the second connecting piece so as to drive the first connecting piece and the second connecting piece to pinch one end of the arm rod, and the pressing assembly is positioned between the first connecting piece and the second connecting piece and driven by the driving member to press against the friction member.

2. The articulated structure according to claim 1, wherein the pressing assembly comprises one or two selected from the group consisting of a first clamping member and a second clamping member.

3. The articulated structure according to claim 2, wherein the first clamping member is fixed to a side of the first connecting piece facing the second connecting piece, the first clamping member is sleeved outside the screw of the driving member, a side of the first clamping member away from the first connecting piece forms a first clamping surface, an outer diameter of the first clamping surface is gradually reduced from the first connecting piece to the second connecting piece, and the contact area of the friction member to the first clamping surface forms a first mating surface.

4. The articulated structure according to claim 2, wherein the second clamping member is fixed to a side of the second connecting piece facing the first connecting piece, the second clamping member is threadedly connected with the screw of the driving member, a second clamping surface is formed from a side of the second clamping member away from the second connecting piece, an outer diameter of the second clamping surface is gradually reduced from the second connecting piece to the first connecting piece, and the contact area of the friction member to the second clamping surface forms a second mating surface.

5. A suspension arm stand, comprising:
a base;
a first arm comprising at least one first arm rod;
a second arm comprising at least one second arm rod; and
the articulated structure according to claim 1; wherein
one end of the first arm is articulated to the base via the articulated structure, and one end of the second arm is articulated to the other end of the first arm via the articulated structure.

6. The suspension arm stand according to claim 5, wherein the first arm comprises two first arm rods, and the two first arm rods are parallel to each other; and
the second arm comprises two second arm rods, and the two second arm rods are parallel to each other.

7. The suspension arm stand according to claim 5, further comprising at least one first elastic member for keeping the other end of the first arm rod with a swing-upward tendency, the articulated structure between the first arm and the base is connected to one end of the first elastic member, and the other end of the first elastic member is connected to a middle portion of the first arm rod.

8. The suspension arm stand according to claim 6, further comprising at least one first elastic member for keeping the other end of the first arm rod with a swing-upward tendency, the articulated structure between the first arm and the base is connected to one end of the first elastic member, and the other end of the first elastic member is connected to a middle portion of the first arm rod.

9. The suspension arm stand according to claim 7, wherein the first elastic member is accommodated in the first arm rod, and the first arm rod has a first through slot for one end of the first elastic member to pass through.

10. The suspension arm stand according to claim 8, wherein the first elastic member is accommodated in the first arm rod, and the first arm rod has a first through slot for one end of the first elastic member to pass through.

11. The suspension arm stand according to claim 5, further comprising at least one second elastic member for keeping the other end of the second arm rod with a swing-upward tendency, the articulated structure between the first arm and the second arm is connected to one end of the second elastic member, and the other end of the second elastic member is connected to a middle portion of the second arm rod.

12. The suspension arm stand according to claim 6, further comprising at least one second elastic member for keeping the other end of the second arm rod with a swing-upward tendency, the articulated structure between the first arm and the second arm is connected to one end of the second elastic member, and the other end of the second elastic member is connected to a middle portion of the second arm rod.

13. The suspension arm stand according to claim 6, further comprising at least one second elastic member for keeping the other end of the second arm rod with a swing-upward tendency, the articulated structure between the first arm and the second arm is connected to one end of the second elastic member, and the other end of the second elastic member is connected to a middle portion of the second arm rod.

14. The suspension arm stand according to claim 12, wherein the second elastic member is accommodated in the second arm rod, and the second arm rod has a second through slot for one end of the second elastic member to pass through.

15. The suspension arm stand according to claim 13, wherein the second elastic member is accommodated in the second arm rod, and the second arm rod has a second through slot for one end of the second elastic member to pass through.

16. The suspension arm stand according to claim 5, wherein the base comprises a supporting tube and a damping sleeve, the articulated structure between the first arm and the base has a rotation shaft, the rotation shaft is inserted into the damping sleeve and rotatably connected to the damping sleeve, and the damping sleeve is mounted into the supporting tube; and
a side wall of the damping sleeve has an allowance groove for keeping the damping sleeve with a contraction allowance.

17. The suspension arm stand according to claim 5, further comprising a clamping assembly fixed on the base, wherein the clamping assembly comprises a fixed clamping plate, a connecting plate with one end fixed on the fixed clamping plate, a supporting plate fixed on the other end of the connecting plate, a movable clamping plate placed on a side of the supporting plate close to the fixed clamping plate, and a threading bolt connected to the supporting plate and with one end fixed to the movable clamping plate to drive the movable clamping plate to cooperate with the fixed clamping plate for clamping.
